(19) United States
(12) Patent Application Publication
(10) Pub. No.: US 2002/0109666 A1
(43) Pub. Date: Aug. 15, 2002

(54) Input device for use with a computer system

(76) Inventors: Ji-Hyung Lee, Incheon-shi (KR); Jong-min Park, Incheon-shi (KR); Sang-Sug Lee, Seoul (KR); II-Kwon Youm, Seoul (KR)

Correspondence Address: SEYFARTH SHAW, Suite 4200, 55 East Monroe Street, Chicago, IL, 60603-5803, US

(21) Appl. No.: 09/870,866

(22) Filed: May 30, 2001

(30) Foreign Application Priority Data
Feb. 15, 2001 (KR) 2001-7599

(51) Int. Cl. G09G 5/00

(52) U.S. Cl. 345/156

(57) ABSTRACT

An input device for use with a computer system is provided with a station connected to the computer system, supplied with an electric power therefrom, transmitting data of a plurality of connector for receiving various key value entries, which are formed on right, left, front and rear sides of the station, and peripheral devices connected to the computer system, controlling ports for communicating with the outside peripheral devices, and outputting input/output key values and data after process to the computer system, and a key pad by which the key entries for different purposes can be input via the connector of the station.

### FIELD OF THE INVENTION

The present invention relates to an input device for use with a computer system, and, more particularly, to an input device for use with a computer system, wherein a station of a main member is connected to the computer system, and a key group having a particular function is connected to the station, which can be formed by combining a plurality of keys and exchanged with other one, with peripheral devices being capable of connected to the computer system through the station.

### DESCRIPTION OF THE PRIOR ART

Recently, computer software have been functionally developed to become more specialized ones due to advancements of surrounding techniques, providing the user with more convenient computing environment, e.g., Graphic User Interface (GUI). However, these software provide exceedingly various menus and require complex key entries from the user, allowing the user to have difficulties to follow the continued developments of the software.

Although the difficulties may be caused by various factors, one is a configuration of an input device for the computer system which still remains unchanged since the initial computer industry.

A keyboard has important roles as the input device for the computer system. However, one of the parts associated with the computer system which have much difficulties to be changed into other forms is the keyboard. That is, in the recent keyboard system, it is impossible to freely change the arrangements of the character keys or functional keys which are set up as standards, and fundamental principles, e.g., a particular key must be pressed to send input signals to the computer system.

Accordingly, the developments of the hardware as well as the software for the computer system must be fitted into the standardized key codes to have a reduced degree of freedom in their design processes.

Under the environment of the current operating system where the universal code support and the multi-lingual support are becoming common requirements, the input method or manner like using the present input devices cannot follow such development of the computing environment.

Of course, much technical improvements have been brought into the keyboard itself. However, most of them are related to only simple key configuration or appearance of the keyboard. Recently, a keyboard having a configuration where a printed circuit board (PCB) is covered with an insulating membrane and an electrical connection is obtained by allowing a conductive rubber key to push a carbon pattern is widespreadly used instead of the conventional keyboard having combined mechanical switches.

The keyboard having such configuration described above has advantages in that it has a reduced manufacturing cost, a good assembling workability and a good mechanical stability. For this reason, most of the keyboards employ the configuration described above.

However, in spite of such mechanical developments, the keyboard which still remains unchanged compared with the rapidly diversified and complicated function and applicability of the computer system and has much limitations in use, causes the user to feel inconvenient in using the computer system and hence complex applications.

In other words, in a case of computer application for a composing and playing the piano, it is not easy to play the piano using a general keyboard. Further, in a case of computer application for kids which requires only limited key entries, using a keyboard having more than 100 keys may give more confused computing environment.

In order to overcome the inconvenient factors described above, the applicant has proposed new keyboards capable of replacing the conventional keyboards which have a conception of giving a first consideration to the user and can maximize efficiencies of comprehension and study by providing more familiar and visually stabilized environment, in order to embody a total interface covering diversified and complicated computer applications. These keyboards are disclosed in Korean Patent Application No. 10-1999-51068 filed on Nov. 17, 1999 and entitled “keyboard for a computer system having a replaceable key pad”, and in Korean Patent Application No. 10-2000-5028 filed on Feb. 2, 2000 and entitled “keyboard for a computer system having a replaceable key group”.

In the patents described above, a certain key group can be removed and a key group having a different arrangement or a different function can replace the removed key group, with the configuration of the conventional keyboard being still preserved, in order to form keyboards applicable to diversified computing environment.

### SUMMARY OF THE INVENTION

It is, therefore, a primary object of the invention to provide an input device for use with a computer system wherein a keyboard is basically connected to or disconnected from a station connected to the computer system in order to conveniently use the keyboard in various applications, e.g., key entries for editing a document file, and peripheral devices can be connected to the computer system by means of the station.

In order to achieve the object, the present invention provides an input device for use with a computer system, including a station connected to the computer system, supplied with an electric power therefrom, transmitting data of a plurality of connector for receiving various key value entries, which are formed on right, left, front and rear sides of the station, and data of peripheral devices connected to the computer system, controlling ports for communicating with the outside peripheral devices, and outputting input/output key values and data after process to the computer system, and a key pad by which the key entries for different purposes can be input via the connector of the station.

In accordance with the present invention, there is provided an extension bar having ports through which data from the computer system on the peripheral devices are input/output to/from those peripheral devices, generating data for a special function, and outputting to the computer system through the station.

In accordance with the present invention, there is provided a wing pad connected to either one of both lateral connectors of the plurality of connectors of the station, the wing pad for entries of keys newly combined and used for a special purpose.

In the present invention constructed in this manner, when the extension bar is connected to the station connected to the computer system, a security process can be performed by using the key values input through the key pad and the function provided by the extension bar; and a plurality of different keyboards having very diversified specifications and keys arranged in different manners other than a standard keyboard specification are available by connecting the wing pad through the connector, which includes a plurality of keys combined and used for a certain computer program.

### BRIEF DESCRIPTION OF THE DRAWINGS

The above and other objects and features of the instant invention will become apparent from the following description of preferred embodiments taken in conjunction with the accompanying drawings, in which:

FIG. 1 shows a block diagram of an inventive input device for use with a computer system;

FIG. 2 depicts a station connected to a key pad for entries of characters of the inventive input device;

FIG. 3 represents a station connected to a key pad of a piano keyboard of the inventive input device; and

FIG. 4 represents a station connected to a left-wing pad and a key pad for entries of characters of the inventive input device.

### DETAILED DESCRIPTION OF THE PREFERRED EMBODIMENTS

Preferred embodiments of the present invention are now described with reference to an accompanying drawings.

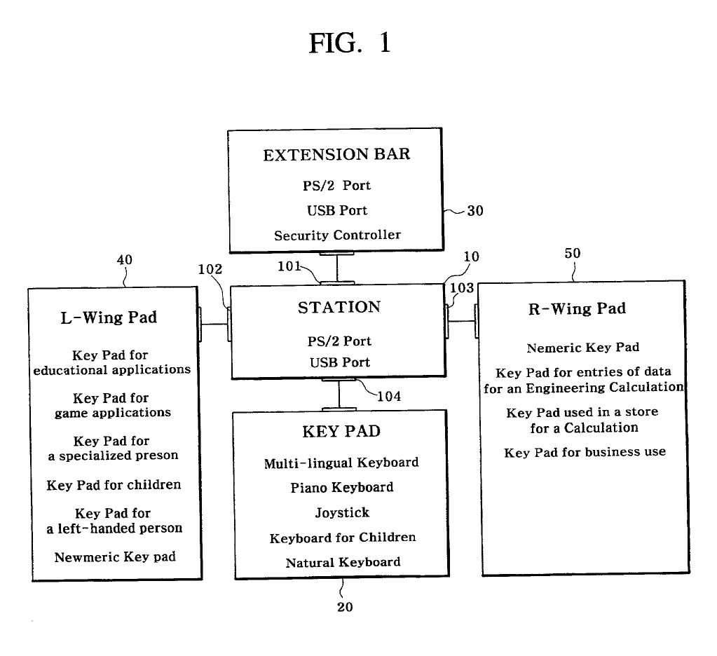

FIG. 1 illustrates a block diagram of an input device for a computer system in accordance with the present invention.

As shown, the inventive input device includes a station 10 connected to a computer system (not shown), supplied with an electric power therefrom, transmitting data of a plurality of connector 101, 102, 103, 104 for receiving various key value entries, which are formed on right, left, front and rear sides of the station 10, and peripheral devices connected to the computer system, controlling a serial port, a parallel port, a PS/2 port and a USB port, etc., for communicating with the outside peripheral devices such as a speaker system, a microphone, a headphone, a mouse and a joystick, and provided with the serial port, the parallel port, the PS/2 port and the USB port, etc., for a connection with the peripheral devices to output to the computer system after processing the input/output key values and data, and a key pad 20 by which the key entries for different purposes can be input via the front connector 104 of the station 10.

For example, the key pad 20 may include various types of keyboards having a key different from one another in shape and size, e.g., a multi-lingual keyboard, a piano keyboard, a joystick, a keyboard for children, and a natural keyboard, etc.

An extension bar 30 is connected to the station 10 by using the rear connector 101 of the station 10, which has the serial port, the parallel port, the PS/2 port and the USB port, etc., through which the data from the computer system related to the peripheral devices such as the speaker system, the microphone, the headphone, the mouse, the joystick, etc., are input/output to/from those peripheral devices. The extension bar 30 generates data for a special function for allowing the data output from a security controller or different kinds of devices for key entries to be converted into general codes for the keyboard and to be input to the computer system through the station 10.

Accordingly, the peripheral devices connected to the computer system are connected to one another via the extension bar 30.

In addition, a right-wing pad 50 is connected to the right connector 103 of the station 10, which includes various combined keys functioning as a numeric key pad, a key pad for entries of data for an engineering calculation, and a key pad used in a store for a calculation or the like. The right-wing pad 50 is mainly used for work which can be completed by mainly operating keys or work which does not requiring much movements of the mouse. A left-wing pad 40 is connected to the left connector 102 of the station, which includes various combined keys capable of being used for the game applications, the educational applications, or the applications for a study purpose or a specialized person or a left-handed person, cooperating with the movement of the mouse.

As a preferred embodiment, the station 10 has a separate key matrix including 48 keys of 16×3 in addition to the conventional key matrix of 16×8 in order to expand commands by the keys of the input device, uses a controller of a series of 8051. The key matrix is configured to use 27 ports of total 32 ports, except for 5 ports which must be included and used in the general keyboard, e.g., Caps Lock, Scroll Lock, Num Lock, Clock and Data.

Accordingly, in the station 10, key entries through the left-wing pad 40 or the right-wing pad 50 other than the general keyboard output scan codes defined in an expanded table.

In the input device constructed in this manner, when the key pad 20, the right-wing pad 50 or the left-wing pad 40 is pressed, corresponding scan code of the pressed key is recorded.

The key scanning is normally performed by examining the port in a column (or row) concurrently lowered to a lower electric potential when the electric potential of ports in a row (column) is lowered to the lower electric potential, with one port at a time, after all of the ports are set in a state of higher electric potential. The detected scan code is recorded.

Then, the recorded scan code is sent to the keyboard controller of the computer system. Next, an interrupt vector function of the ROM-BIOS of the computer system for the keyboard translates the scan code and restores the scan code together with the translated code in a keyboard buffer. Next, the general key and the expanded code are translated from the key values in the keyboard buffer and used for the application programs.

In order to enable exact operations of the specialized keyboard and the expanded key set as well as the basic keyboard operation performed by the key pad 20 and the left-wing pad and right-wing pad 40 and 50 for the computer system, software, e.g., a device driver and a windows-agent program under an operating system are required.

In this case, the device driver controls the function of each of the keys of the key pad 20 and the left-wing pad and the right-wing pad 40 and 50 which are detachably attached to the station, supports dynamic loading of the device, and supports a free exchange of the driver, when detachable keys are removed or are replaced with other ones.

For this reason, the user can enjoy amusement games, e.g., “STARCRAFT” in more convenient manner by using the detachable key pad. Further, he can play music after replacing the key pad with the key pad for the piano keyboard.

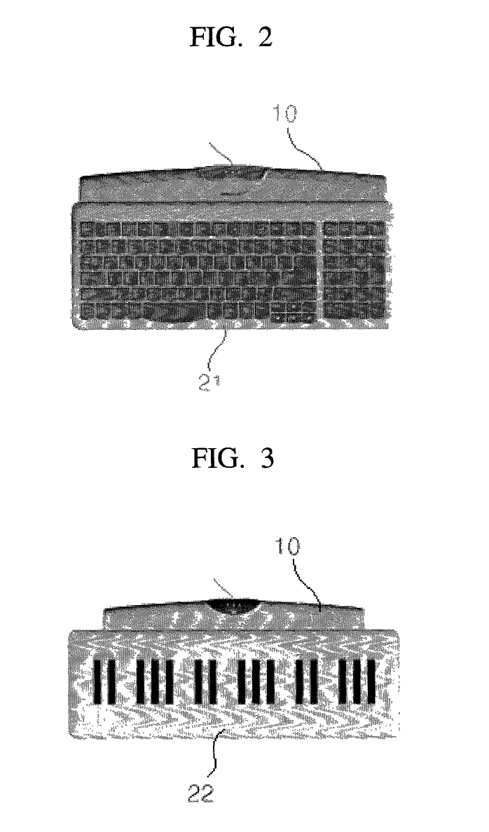

FIG. 2 depicts the station and a key pad for entries of characters connected to the station, in the inventive input device for use with the computer system.

As shown, the station 10 is connected to the computer system via the PS/2 port or the USB port; and the key pad 21 for entries of the characters is connected to the station 10 through the front connector 104.

Accordingly, by these connection described above, the inventive input device in this embodiment functions as the general keyboard.

FIG. 3 illustrates the station connected to the piano key pad in the inventive input device for use with the computer system.

As shown, the station 10 is connected to the computer system via the PS/2 port or the USB port; and the piano key pad 22 is connected to the station 10 through the front connector 104.

As described above, when the piano key pad 22 is employed as the keyboard, the user can more freely play the piano under a music related program, compared with the general keyboard for entries of the characters.

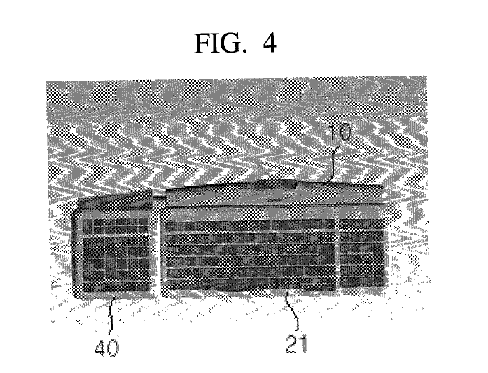

Further, FIG. 4 shows the station connected to the left-wing pad and the key pad in the inventive input device for use with the computer system.

As shown, the station 10 is connected to the computer system via the PS/2 port or the USB port; and the left-wing pad 40 where keys frequently used in the application for a stock trading are arranged is connected to the station via the left connector 102, with the general key pad 21 for entries of the general characters connected to the front connector 104.

Meanwhile, when the extension bar 30 having the security function is connected to the station 10, whole input device as well as the key value input by the key pad 20 can be kept in secure condition against an undesirable information outflow by means of the security controller within the extension bar 30.

The key pad 20, and the left-wing pad and the right-wing pad 40 and 50 can be freely arranged or changed in their positions or orientations on the desk, since they are connected to the connectors 101, 102, 103, or 014 of the station 10 via flexible cables.

On the other hand, when, for example, BLUE TOOTH, one of the short range wireless communication technologies is provided to the connectors 101, 102, 103 and 104 formed on the station 10, the key pad 20, and the left-wing pad and the right-wing pad 40 and 50 can be wirelessly connected to the station 10 without any spatial limit.

As described above, the present invention having a configuration where the station of a main member is connected to the computer system and a key group having a particular function is connected to the station, which can be formed by combining the keys and exchanged with other one is a total input device for the computer system which can be fitted into most applications or programs to provide the user with the convenience and may have an infinite range in its change and function.

Further, the inventive input device has an advantage in that it allows the peripheral devices to be connected to the computer system through itself.

On the other hand, when the BLUE TOOTH of the short range wireless communication technologies is provided to the connectors formed on the station, the inventive input device has an advantage in that the key pad, and the left-wing pad and the right-wing pad can be wirelessly connected to the station without any spatial limit.

Although the invention has been shown and described with respect to the preferred embodiments, it will be understood by those skilled in the art that various changes and modifications may be made without departing from the spirit and scope of the invention as defined in the following claims.

What is claimed is:

1. An input device for use with a computer system comprising:
a station connected to the computer system, supplied with an electric power therefrom, transmitting data of a plurality of connector for receiving various key value entries, which are formed on right, left, front and rear sides of the station, and data about peripheral devices connected to the computer system, controlling ports for communicating with the outside peripheral devices, and outputting input/output key values and data after process to the computer system; and
a key pad by which the key entries for different purposes can be input via the connector of the station.

2. The input device of claim 1, wherein said key pad is selected from a group including a multi-lingual keyboard, a piano keyboard, a joystick, a keyboard for children, and a natural keyboard.

3. The input device of claim 1, wherein a blue tooth system of a short range wireless communication system is mounted to the connectors formed on the station.

4. The input device of claim 1, wherein the key pad, and a left-wing pad and a right-wing pad are connected to the connectors of the station via flexible cables.

5. The input device of claim 1, further comprising at least a wing pad connected to either one of both lateral connectors of the plurality of connectors of the station, the wing pad for entries of keys newly formed for a special purpose.

6. The input device of claim 1, further comprising an extension bar having ports through which data from the computer system on the peripheral devices are input/output to/from those peripheral devices, generating data for a special function, and outputting to the computer system through the station.

7. The input device of claim 6, further comprising at least a wing pad connected to either one of both lateral connectors of the plurality of connectors of the station, the wing pad for entries of keys newly formed for a special purpose.

8. The input device of claim 7, wherein said wing pad is one selected from a group including a numeric key pad, a key pad for entries of data for an engineering calculation, a key pad used in a store for a calculation, a key pad for game applications, a key pad for educational applications, a key pad for applications for a study purpose, a key pad for a specialized person, and an expanded key pad for a left-handed person.
